(19) United States
(12) Patent Application Publication
(10) Pub. No.: US 2014/0210772 A1
(43) Pub. Date: Jul. 31, 2014

(54) CAPACITIVE TOUCH PANEL, SENSING METHOD THEREOF, TOUCH DEVICE USING THE SAME, AND INPUT APPARATUS

(71) Applicant: PIXART IMAGING INC., Hsin-Chu (TW)

(72) Inventors: KUAN-YI YANG, Hsin-Chu (TW); CHI-CHIEH LIAO, Hsin-Chu (TW)

(73) Assignee: PIXART IMAGING INC., Hsin-Chu (TW)

(21) Appl. No.: 14/093,449

(22) Filed: Nov. 30, 2013

(30) Foreign Application Priority Data
Jan. 25, 2013 (TW) 102102911

(51) Int. Cl. G06F 3/044

(52) U.S. Cl. CPC G06F 3/044
USPC 345/174; 349/12

(57) ABSTRACT

The present disclosure provides a capacitive touch panel, a sensing method thereof, a touch device using the same, and an input apparatus. The capacitive touch panel includes a substrate, a plurality of first scan lines, and a plurality of second scan lines. The first scan lines and the second scan lines are respectively formed on the substrate wherein the first scan lines and the second scan lines are interlaced with each other. The first scan lines and the second scan lines are capacitively coupled to each other forming a plurality of sensing regions. Moreover, any one of the second scan lines can formed a sensing region with one or more first scan lines.

### BACKGROUND

1. Technical Field

The present disclosure relates to a touch panel, a sensing method thereof, a touch device using the same, and an input apparatus, in particular, to a capacitive touch panel, a sensing method thereof, a touch device using the same, and an input apparatus.

2. Description of Related Art

Recently, electronic devices such as cellular phone, laptop, tablet, and personal digital assistance (PDA) are mostly equipped with capacitive touch panels as input/output interfaces for the electronic devices. Users can operate the electronic device with the input/output interface provided to correspondingly control the operations of the electronic device. A conventional capacitive touch panel generally has a plurality of interlaced scan lines disposed thereon and whether the capacitive touch panel has been touched and the location of the associated touch position can be determined by detecting the capacitance variation of any two interlaced scan lines.

However, a large number of scan lines is required for the conventional capacitive touch panel to provide more accurate positioning capability, which in turn increases the number of pins required on the control chip and the number of associated detecting circuits. Additionally, more power would be consumed by the control chip as the number of the detection signals required to be processed by the control chip during the operation of the capacitive touch panel would increase as well. Furthermore, the size of the control chip and the area occupancy thereof would also increase with increase in the number of scan lines, and thereby increases the production cost.

### SUMMARY

Accordingly, the instant disclosure provides a capacitive touch panel, a sensing method, a touch device, and an input apparatus, which can reduce the number of scan lines required and lower the overall power consumption by grouping scan lines.

An exemplary embodiment of the present disclosure provides a capacitive touch panel which includes a substrate, a plurality of first scan lines and a plurality of second scan lines. The first scan lines are formed on the substrate. The first scan lines are arranged in parallel along a first axis (e.g., x axis) of the substrate. The second scan lines are formed on the substrate. The second scan lines are arranged in parallel along a second axis (e.g., y axis) of the substrate. The second scan lines are interlaced with the first scan lines, wherein the second scan lines are capacitively coupled to the first scan lines forming a plurality of sensing regions. The ith first scan line is capacitively coupled to the jth second scan line forming the kth sensing region. The ith first scan line and the i+1th first scan line are simultaneously capacitively coupled to the jth second scan line collectively forming the k+1th sensing region. The i+1th first scan line is capacitively coupled to the jth second scan line forming the k+2th sensing region. In which, i, j, and k are integers.

An exemplary embodiment of the present disclosure provides a touch device, which includes a capacitive touch panel and a controller. The capacitive touch panel further includes a substrate, a plurality of first scan lines, and a plurality of second scan lines. The first scan lines are formed on the substrate and the first scan lines are arranged in parallel along a first axis (e.g., x axis) of the substrate. The second scan lines are formed on the substrate and the second scan lines are arranged in parallel along a second axis (e.g., y axis) of the substrate. The second scan lines are interlaced with the first scan lines, wherein the second scan lines are capacitively coupled to the first scan lines forming a plurality of sensing regions. The ith first scan line is capacitively coupled to the jth second scan line forming the kth sensing region. The ith first scan line and the i+1th first scan line are simultaneously capacitively coupled to the jth second scan line collectively forming the k+1th sensing region. The i+1th first scan line is capacitively coupled to the jth second scan line forming the k+2th sensing region. In which, i, j, and k are integers. The controller is coupled to the first scan lines and the second scan lines, respectively. The controller determines whether any of the sensing regions has been touched based on the scan results of the first scan lines and the second scan lines.

An exemplary embodiment of the present disclosure provides a capacitive touch panel, which includes a substrate, a first group of scan lines, a second group of scan lines, and a third group of scan lines. The first group of scan lines, the second group of scan lines, and the third group of scan lines are formed on the substrate, respectively. The first group of scan lines further includes a plurality of conducting wires, which are arranged in parallel along a first axis (e.g., y axis) of the substrate. The second group of scan line includes a plurality of conducting wires, which are arranged in parallel along the first axis (e.g., y axis) of the substrate. The third group of scan lines includes a plurality of conducting wires, which are arranged in parallel along a second axis (e.g., x axis) of the substrate. The conducting wires in the third group of the scan lines are interlaced with the conducting wires in the first and the second groups of scan lines, while electrically isolated from the conducting wires in the first and the second groups of scan lines. The zth conducting wire of the first group of scan lines is connected to the zth conducting wires of the second group of scan lines in series, wherein z is an integer.

An exemplary embodiment of the present disclosure provides a sensing method, which is adapted for the aforementioned capacitive touch panel. The method includes the following steps. A plurality of first scan lines and a plurality of second scan lines interlaced with the first scan lines disposed on a substrate are scanned. Whether any of a plurality of sensing regions formed between the first scan lines and the second scan lines has been touched is subsequently determined according to the scan results of the first and the second scan lines. When only detects change in the capacitance value sensed by the ith first scan line and the jth second scan line, determines that the kth sensing region has been touched. When simultaneously detects changes in the capacitance values sensed by the ith first scan line, the i+1th first scan line, and the jth second scan line, determines that the k+1th sensing region has been touched. When only detects change in the capacitance value sensed by the i+1th first scan line and the jth second scan line, determines that the k+2th sensing region has been touched. In which, i, j, and k are integers.

An exemplary embodiment of the present disclosure provides another sensing method, which is adapted for the aforementioned capacitive touch panel. The method includes the following steps. A plurality of first scan lines and a plurality of second scan lines interlaced with the first scan lines disposed on a substrate are scanned. Whether any of a plurality of sensing regions formed between the first scan lines and the second scan lines have been touched is subsequently determined according to the scan results of the first and the second scan lines. When only detects change in the capacitance value sensed by the ith first scan line and the jth second scan line, determines that the kth sensing region has been touched. When simultaneously detects changes in the capacitance values sensed by the ith first scan line, the i+1th first scan line, and the jth second scan line, determines that the k+1th sensing region has been touched. When only detects change in the capacitance value sensed by the i+1th first scan line and the jth second scan line, determines that the k+2th sensing region has been touched. When simultaneously detects changes in the capacitance values sensed by the i+1th first scan line, the i+2th first scan line, and the jth second scan line, determines that the k+3th sensing region has been touched. When only detects change in the capacitance value sensed by the i+2th first scan line and the jth second scan line, determines that the k+4th sensing region has been touched. In which, i, j, and k are integers.

An exemplary embodiment of the present disclosure further provides a capacitive touch panel, which includes a substrate, a plurality of first scan lines, and a plurality of second scan lines. The first scan lines are formed on the substrate, and the first scan lines are arranged in parallel along a first axis (e.g., x axis) of the substrate. The second scan lines are formed on the substrate. The second scan lines arranged in parallel along a second axis (e.g., y axis) of the substrate, and the second scan lines are interlaced with the first scan lines. The second scan lines are capacitively coupled to the first scan lines forming a plurality of sensing regions. There is at least a sensing region covers a plurality of first scan lines.

To sum up, an exemplary embodiment of the present disclosure provides a capacitive touch panel, a sensing method thereof, a touch device, and an input apparatus, in which the capacitive touch panel can accurately and precisely locate touch positions, while effectively lower the overall power consumption by reducing the number of scan lines required and the pins needed on the control chip. Accordingly, the associated complexity and the production cost of the touch control circuitry can be reduced, while the operational efficiency of the capacitive touch panel can be increased.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a circuit layout on a capacitive touch panel provided in accordance to an exemplary embodiment of the present disclosure.

FIG. 2 is a schematic diagram of a touch device provided in accordance to an exemplary embodiment of the present disclosure.

FIG. 3 is a schematic diagram of a circuit layout on a capacitive touch panel provided in accordance to an exemplary embodiment of the present disclosure.

FIG. 4 is a schematic diagram of a circuit layout on a capacitive touch panel provided in accordance to an exemplary embodiment of the present disclosure.

FIG. 5 is a schematic diagram of a circuit layout on a capacitive touch panel provided in accordance to an exemplary embodiment of the present disclosure.

FIG. 6 is a schematic diagram of an input apparatus provided in accordance to an exemplary embodiment of the present disclosure.

FIG. 7 is a diagram illustrating an implementation of the input apparatus in a mouse provided in accordance to an exemplary embodiment of the present disclosure.

FIG. 8-1 and FIG. 8-2 are flowchart diagrams respectively illustrating a sensing method for a capacitive touch panel provided in accordance to an exemplary embodiment of the present disclosure.

FIG. 9-1 and FIG. 9-2 are flowchart diagrams respectively illustrating alternate sensing method for a capacitive touch panel provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

(An Exemplary Embodiment of a Capacitive Touch Panel)

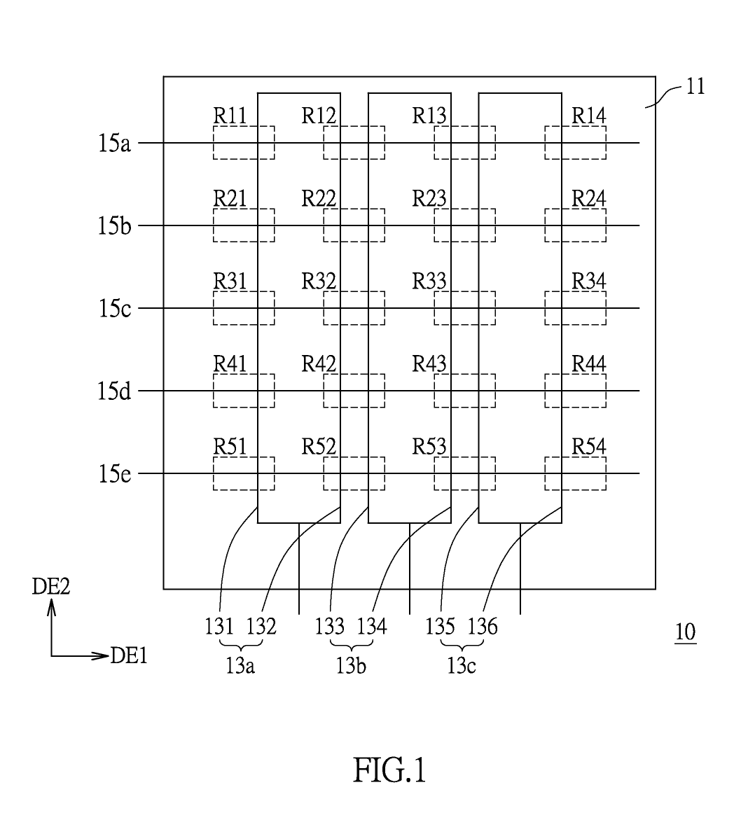

Please refer to FIG. 1, which shows a schematic diagram illustrating a capacitive touch panel provided in accordance to an exemplary embodiment of the present disclosure. The capacitive touch panel 10 may be used in an electronic device including but not limited to a cellular phone, a laptop, a tablet, a personal digital assistant (PDA), a keyboard, and a mouse.

The capacitive touch panel 10 may be a signal-layer or dual-layer capacitive touch panel and the instant disclosure is not limited thereto. The capacitive touch panel 10 includes a substrate 11, a plurality of first scan lines 13a˜13c, and a plurality of second scan lines 15a˜15e. The first scan lines are arranged in parallel along a first axis DE1 direction of the substrate 11. The second scan lines are arranged in parallel along a second axis DE2 direction of the substrate 11.

The direction of the first axis DE1 is perpendicular to the direction of the second axis DE2. For instance, the first axis DE1 may be an X-axis while the second axis may be a Y-axis. The first scan lines 13a˜13c and the second scan lines 15a˜15e arranged on the substrate 11 are interlaced with each other. Specifically, the first scan lines 13a˜13c intersect the second scan lines 15a˜15e, and the first scan lines 13a˜13c are electrically isolated from the second scan lines 15a˜15e.

The first scan lines 13a˜13c are capacitively coupled to the second scan lines 15a˜15e to form a plurality of sensing regions R11˜R54 therebetween. Briefly, at least a first scan line (i.e., the first scan line 13a, 13b, or 13c) disposed on the capacitive touch panel 10 is capacitively coupled with each of the second scan line 15a˜15e to form a plurality of sensing regions at the intersection. That is, any of the first scan lines (i.e., the first scan line 13a, 13b, or 13c) on the capacitive touch panel 10 may be capacitively coupled to each of the second scan lines 15a˜15e to form one or more sensing regions at the intersection.

To put it concretely, the first scan line 13a is capacitively coupled to the second scan line 15a forming the sensing region R11. The first scan line 13a and the first scan line 13b are simultaneously capacitively coupled to the second scan line 15a collectively forming the sensing region R12. The first scan line 13b and the first scan line 13c are simultaneously capacitively coupled to the second scan line 15a collectively forming the sensing region R13. The first scan line 13c is capacitively coupled to the second scan line 15a forming the sensing region R14.

Each of the first scan lines 13a, 13b, and 13c in the instant embodiment further includes two adjacent conducting wires connected in parallel, wherein the two adjacent conducting wires are arranged along the first axis DE1. Particularly, the first scan line 13a includes a conducting wire 131 and a conducting wire 132, wherein the conducting wire 131 is parallel-connected to the conducting wire 132. The first scan line 13b includes a conducting wire 133 and a conducting wire 134, wherein the conducting wire 133 is parallel-connected to the conducting wire 134. The first scan line 13c includes a conducting wire 135 and a conducting wire 136, wherein the conducting wire 135 is parallel-connected to the conducting wire 136.

Accordingly, the conducting wire 131 of the first scan line 13a is capacitively coupled to the second scan line 15a forming the sensing region R11. The conducting wire 132 of the first scan line 13a and the conducting wire 133 of the first scan line 13b are simultaneously capacitively coupled to the second scan line 15a collectively forming the sensing region R12. The conducting wire 134 of the first scan line 13b and the conducting wire 135 of the first scan line 13c are simultaneously capacitively coupled to the second scan line 15a collectively forming the sensing region R13. The conducting wire 136 of the first scan line 13c is capacitively coupled to the second scan line 15a forming the sensing region R14.

Similarly, the conducting wires 131˜136 of the respective first scan lines 13a˜13c are individually capacitively coupled to the second scan line 15b, or simultaneously capacitively coupled to the second scan line 15b with the adjacent conducting wire to form a plurality of sensing regions R21˜R24. The conducting wires 131˜136 of the respective first scan lines 13a˜13c are individually capacitively coupled to the second scan line 15c, or simultaneously capacitively coupled to the second scan line 15c with the adjacent conducting wire to form a plurality of sensing regions R31˜R34 and so on.

In summary, the second scan line 15a˜15e on the capacitive touch panel 10 may capacitively coupled to one or more first scan lines to form a sensing region. In the instant embodiment, at least a first scan line on the capacitive touch panel 10 is capacitively coupled to any of the second scan lines forming at least two sensing regions. Alternatively, two adjacent first scan lines are capacitively coupled to one second scan line to form at least a sensing region on the capacitive touch panel 10. In other words, at least a sensing region on the capacitive touch panel 10 covers one or more first scan lines.

During the operation of the capacitive touch panel 10, which of the sensing regions has been touched can be determined by simultaneously detecting and comparing variations in the coupling capacitance between two adjacent first scan lines (i.e., first scan lines 13a and 13b or first scan lines 13b and 13c) and the respective second scan line 15a˜15e so as to correspondingly determine the touch position.

For instance, when only detects change in the coupling capacitance sensed by the first scan line 13a and the respective second scan line 15a (e.g., the change in the coupling capacitance is greater than a predetermined sensing threshold), determines that the sensing region R11 has been touched. When simultaneously detects change in the coupling capacitance sensed by the first scan line 13a, the first scan line 13b and the respective second scan line 15a (e.g., the change in the capacitance value is greater than the predetermined sensing threshold), determines that the sensing region R12 has been touched. When simultaneously detects change in the coupling capacitances sensed by the first scan line 13b, the first scan line 13c, and the respective second scan line 15a (e.g., the change in the coupling capacitances are greater than the predetermined sensing threshold), determines that the sensing region R13 has been touched. When only detects change in coupling capacitance sensed by the first scan line 13c and the respective second scan line 15a (e.g., the change in the coupling capacitance is greater than the predetermined sensing threshold), determines that the sensing region R14 has been touched.

It is worth to note that the predetermined sensing threshold may be configured according to the operational requirement (e.g., voltage level of driving signal) of the capacitive touch panel 10 or the detection requirements, and the present disclosure is not limited thereto.

The capacitive touch panel 10 described only has 20 sensing regions R11˜R54, which are capacitively formed from three first scan lines 13a˜13c arranged along the first axis DE1 and five second scan lines 15a˜15e arranged along the second axis, respectively. However, in practice the number of the sensing regions may be configured by the layout design of the first scan lines 13a˜13c and the second scan lines 15a˜15e. The exact number of first scan lines and the second scan lines may be configured based on the actual dimension of the capacitive touch panel 10, the actual circuitry design, the processing capability, the actual product application, and/or the operational efficiency.

The capacitive touch panel 10 may has a sensing region formed from capacitive coupling between at least a first scan line and the respective interlaced second scan line, and at least two sensing regions formed from capacitive coupling among multiple first scan lines and the respective interlaced second scan line according to the actual operational requirement. As shown in FIG. 1, any of the first scan lines disposed on the capacitive touch panel 10 can form at least two sensing regions with the respective interlaced second scan line.

Additionally, the first scan lines 13a˜13c of the instant embodiment may be driving lines while the second scan lines 15a˜15e may be sensing lines. However, first scan lines 13a˜13c in practice may be sensing lines while the second scan lines 15a˜15e may be driving lines. Hence, the instant embodiment does not limit the type and the operation mode associated with the first scan lines 13a˜13c and the second scan lines 15a˜15e.

It is well known in the field that the operation of the capacitive touch panel basically is to sequentially transmit driving signals to each of the driving lines and sequentially sense the change in the coupling capacitance (e.g., voltage variation) from the sensing signals of the respective sensing line so as to detect and determine the touch position. Those skilled in the art should know that the driving lines consumed relatively high power compare to the sensing lines. Hence by configuring the first scan line 13a˜13c as driving lines and the second scan line 15a˜15e as sensing lines can greatly reduce the number of driving lines thereby effectively reduce the power consumption of the capacitive touch panel 10.

It should be noted that FIG. 1 only serve as an illustration of an embodiment of the capacitive touch panel and the instant disclosure is not limited thereto.

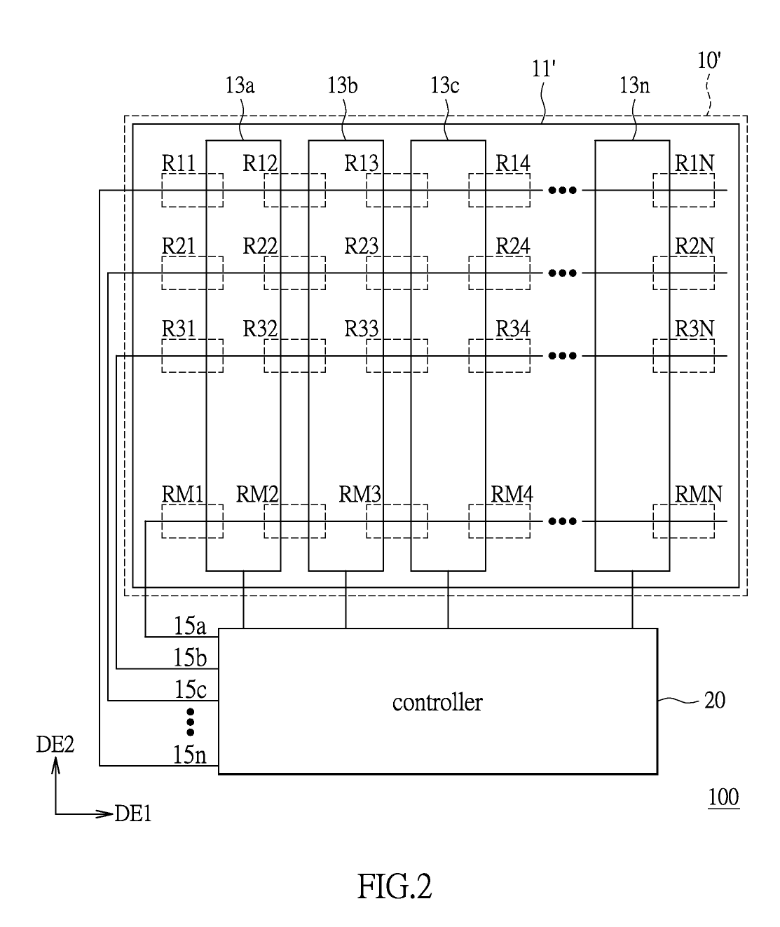

The capacitive touch panel described herein may be integrated in a touch device. As described previously, the exact number of first scan lines and the second scan lines adopted can be increased according to the actual operational requirement to form more sensing region so as to increase the resolution of the capacitive touch panel. Please refer to FIG. 2, which shows a schematic diagram illustrating a touch device provided in accordance to an exemplary embodiment of the present disclosure. The touch device 100 includes a capacitive touch pane 10′ and a controller 20. The capacitive touch panel 10′ is coupled to the controller 20.

As shown in FIG. 2, the capacitive touch panel 10′ includes a substrate 11′, a plurality of first scan lines 13a˜13n arranged along a first axis DE1 direction of the substrate 11′ and a plurality of second scan lines 15a˜15n arranged along a second axis DE2 direction of the substrate 11′. The exact number of the first scan lines and the second scan lines may the same or different depend upon actual operational requirement and the instant embodiment is not limited thereto. Each of the first scan lines 13a˜13n further includes two adjacent conducting wires connected in parallel. The first scan lines 13a˜13n are capacitively coupled to the second scan lines 15a˜15n forming a plurality of sensing regions R1˜RMN, wherein M, N are integers.

Any of the second scan lines 15a˜15n on the capacitive touch panel 10′ may form a sensing region with one or more first scan line 13a˜13n. Alternatively, the capacitive touch panel 10′ has at least a sensing region, which covers multiple first scan lines 13a˜13n. Moreover, at least a first scan line 13a˜13n is capacitively coupled to each of the second scan lines 15a˜15n forming a plurality of sensing regions. The structure of the capacitive touch panel 10′ is essentially the same as the aforementioned capacitive touch panel 10, and further descriptions are therefore omitted.

The controller 20 is respectively coupled to the first scan lines 13a˜13n and the second scan lines 15a˜15n so as to determine whether any of the sensing regions formed has been touched based on the scan results of the first scan lines 13a˜13n and the second scan lines 15a˜15n. The controller 20 further determines which of the sensing regions has been touched based on the scan results of the first scan lines 13a˜13n and the second scan lines 15a˜15n to locate a touch position and generate a touch signal, correspondingly.

Specifically, the controller 20 can simultaneously sequentially transmit driving signals to two adjacent first scan lines (e.g., the first scan lines 13a and 13b, the first scan lines 13b and 13c, and so on) according to a predetermined scanning time when perform a scan operation to the capacitive touch panel 10′ for detecting a location associated with the touch position. The controller 20 further sequentially receives the sensing signals from each of the respective second scan lines 15a˜15n corresponding to the two adjacent first scan lines (e.g., the first scan lines 13a and 13b, the first scan lines 13b and 13c, and so on) so as to detect the change in coupling capacitance associated with the sensing regions (e.g., sensing region R11˜RMN), wherein the sensing regions (e.g., sensing region R11˜RMN) are formed by the second scan lines 15a˜15n and the corresponding interlaced first scan lines 13a˜13n.

For example, when any of the sensing regions R11˜RMN has been touched, the respective second scan line 15a˜15n may generate and output the sensing signal with variation in voltage. The controller 20 can therefore determine the coordinate of at least one touch position based on the voltage variation of the sensing signal and the corresponding driving signal transmitted to the adjacent first scan lines.

In practice, the first scan line 13a˜13n and the second scan line 15a˜15n may be manufactured on the substrate 11′ using lithography process such as exposure, develop, and etching processes. The substrate 11′ may be a transparent insulating substrate such as a glass, a plastic, or any other transparent material with insulating characteristic. The conducting wires of the first scan lines 13a˜13n and the second scan lines 15a˜15n may comprise of transparent conductive material such as indium tin oxide (ITO), Indium zinc oxide (IZO), antimony tin oxide (ATO), aluminum oxide, and etc.

The controller 20 may be implemented by a microcontroller chip (e.g., a touch-control chip) with associated firmware design. The controller 20 may be disposed and arranged on the substrate 11′. For instance, the controller 20 may be disposed on the substrate 11′ by means of adhesion through depositing adhesive material. The controller 20 may also be disposed on a printed circuit board and electrically connected to the first scan lines 13a˜13n and the second scan lines 15a˜15n on the capacitive touch panel 10′ through a flexible printed circuit (FPC) board. It should be noted that the actual configuration and arrangement of the controller 20 may depend up the actual processing and routing requirements, and the present disclosure is not limited thereto.

Incidentally, the touch device 100 and a processing chip (not shown) may be integrated into an input apparatus (not shown) such as a keyboard, a mouse, and the like. The processing chip is electrically connected to the controller 20 for receiving the touch signal corresponding to the touch signal therefrom and executing a predefined special function, accordingly. For instance, when the touch device 100 is adopted in an electronic device such as a cellular phone or a laptop, the processing chip of the touch device 100 may instantly refresh the display of the electronic device, control zoom in/out, and perform dragging operations of an object, or initiate scrolling operation of a window upon receiving the touch signal.

It shall be noted that FIG. 2 merely uses to illustrate a special implementation and application associated with the capacitive touch panel of FIG. 1 and the present disclosure is not limited thereto.

(An Exemplary Embodiment of a Capacitive Touch Panel)

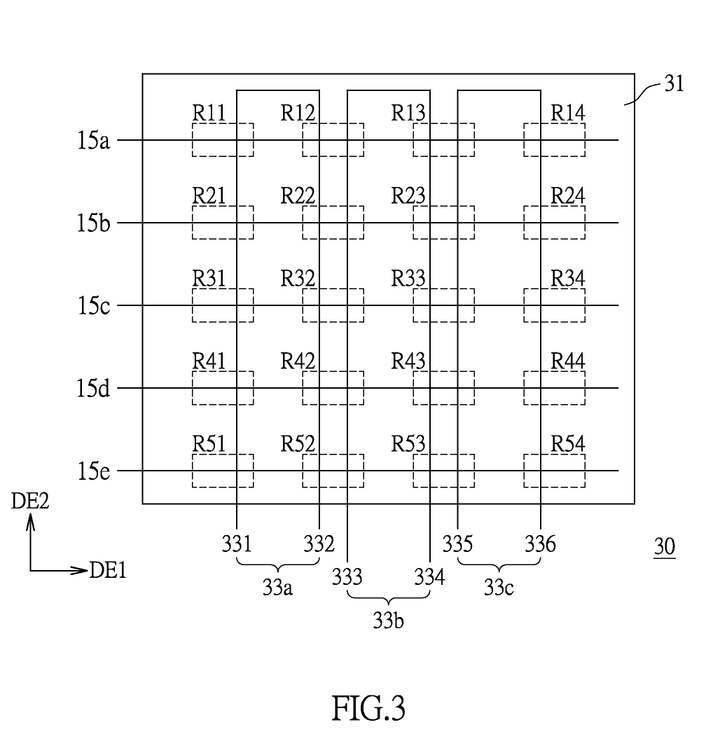

The first scan lines of the aforementioned embodiment are formed of two adjacent conducting wires connected in parallel, but the conducting wires of the first scan line can also be connected in different ways. Please refer to FIG. 3, which shows a schematic diagram of a circuit layout on a capacitive touch panel provided in accordance to an exemplary embodiment of the present disclosure.

The capacitive touch panel 30 includes a substrate 31, a plurality of first scan lines 33a˜33c, and the plurality of second scan lines 15a˜15e. The first scan lines 33a˜33c are arranged in parallel along a first axis DE1 (e.g., x-axis) direction of the substrate 31, and the second scan lines 15a˜15e are arranged in parallel along a second axis DE2 (e.g., y-axis) direction of the substrate 31. The first scan lines 33a˜33c form a plurality of sensing regions R11˜R54 with the second scan lines 15a˜15e. Any of the second scan lines 15a˜15e on the capacitive touch panel 30 may form a sensing region with one or more first scan line 33a˜33c. Alternatively, the capacitive touch panel 30 has at least a sensing region which covers multiple first scan lines 33a˜33c. In the instant embodiment, the first scan lines 33a˜33c are driving lines while the second scan lines 15a˜15e are sensing lines, however the present disclosure is not limited thereto.

The difference between the capacitive touch panel 30 of FIG. 3 and the capacitive touch panel 10 of FIG. 1 is in the circuitry structure of the first scan lines 33a˜33c. In FIG. 3, the first scan lines 33a˜33c includes two conducting lines connected in series. To put it concretely, the first scan line 33a includes a conducting wire 331 and a conducting wire 332, wherein the conducting wire 331 and the conducting wire 332 are series-connected to each other.

As shown in FIG. 3, a first-end of the conducting wire 331 is electrically connected to a respective first-end of the conducting wire 332 while a second-end of the conducting wire 331 and a second-end of the conducting wire 332 are electrically connected to a back-end controller (not shown), respectively. However, in practice, the first-end of the conducting wire 331 may electrically connected to the second-end of the conducting wire 332 (i.e., the farthest end from the first-end of the conducting wire 331). Alternatively, the present disclosure does not limit the connection used herein so long as the conducting wire 331 and the conducting wire 332 are connected in series.

Similarly, the first scan line 33b includes a conducting wire 333 and a conducting wire 334, wherein the conducting wire 333 and the conducting wire 334 are series-connected to each other. A first-end of the conducting wire 333 is electrically connected to a first-end of the conducting wire 334 while a second-end of the conducting wire 333 and a second-end of the conducting wire 334 are electrically connected to the back-end controller, respectively. The first scan line 33c includes a conducting wire 335 and a conducting wire 336, wherein the conducting wire 335 and the conducting wire 336 are series-connected to each other. A first-end of the conducting wire 335 is electrically connected to a first-end of the conducting wire 336 while a second-end of the conducting wire 335 and a second-end of the conducting wire 336 are electrically connected to the back-end controller, respectively.

Accordingly, when the capacitive touch panel 30 and the back-end controller are integrated in a touch device, the back-end controller may for example simultaneously scan the first scan lines 33a and 33b by transmitting driving signals to the conducting wire 331 of the first scan line 33a and the conducting wire 333 of the first scan line 33b so as to detect the location of the touch position through the respective second scan lines 15a˜15e.

Additionally, since the first scan lines of the instant embodiment are formed by connecting two adjacent conducting wires in series, such that the first scan lines and the second scan lines can be routed to connect the controller from one side of the capacitive touch panel 30 when the capacitive touch panel 30 is integrated with the controller. Accordingly, the peripheral circuitry of the capacitive touch panel 30 and the controller may be all routed on the same side thereby simplify the design of the peripheral circuitry and reduce the overall manufacturing complexity of the capacitive touch panel 30.

The rest of the circuitry structure and the operation of the capacitive touch panel 30 in FIG. 3 are essential the same as the capacitive touch panel 10, thus based on the above elaborations, those skilled in the art should be able to infer the operation associated with the capacitive touch panel 30, hence further descriptions are therefore omitted. FIG. 3 is merely used to illustrate an implementation of the capacitive touch panel provided in accordance to the instant embodiment of the present disclosure, and the present disclosure is not limited thereto.

(Another Exemplary Embodiment of a Capacitive Touch Panel)

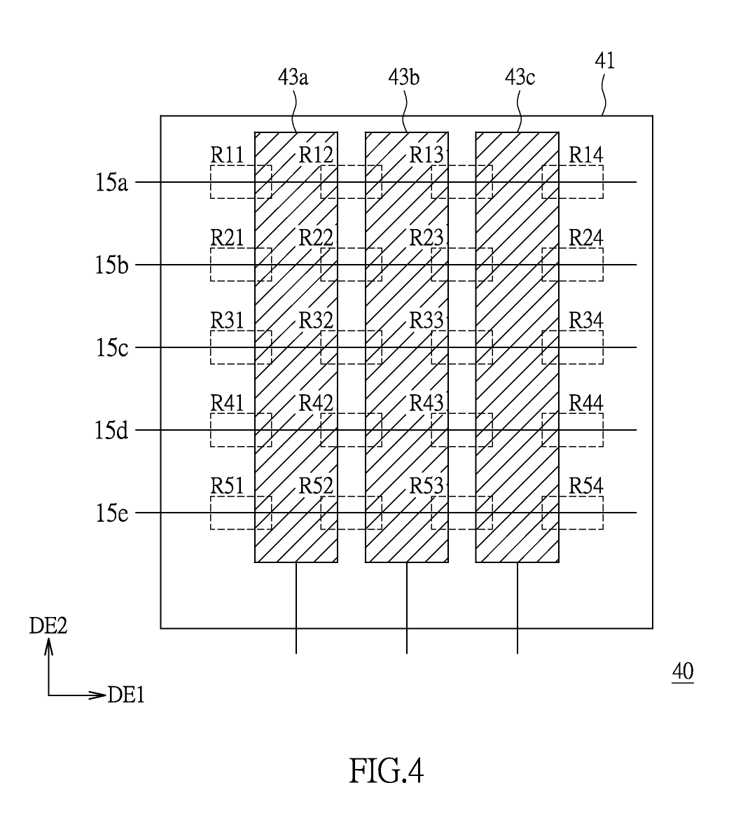

The aforementioned first scan lines are implemented by connecting two adjacent conducting wires in parallel or series, but the first scan lines may also be implemented with other connections. Please refer to FIG. 4, which shows a schematic diagram of a circuit layout on a capacitive touch panel provided in accordance to an exemplary embodiment of the present disclosure.

The capacitive touch panel 40 includes a substrate 41, a plurality of first scan lines 43a˜43c, and the plurality of second scan lines 15a˜15e. The first scan lines 43a˜43c are arranged in parallel along a first axis DE1 direction (e.g., x-axis) of the substrate 41, and the second scan lines 15a˜15e are arranged in parallel along a second axis DE2 (e.g., y-axis) direction of the substrate 41. The first scan lines 43a˜43c form a plurality of sensing regions R11˜R54 with the second scan lines 15a˜15e.

In particular, each of the second scan lines 15a˜15e arranged on the capacitive touch panel 40 may form a sensing region with one or multiple of the first scan lines 43a˜43c. At least a first scan line 43a˜43c on the capacitive touch panel 40 intersects each of the second scan lines 15a˜15e to form at least two sensing regions. The first scan lines 43a˜43c in the instant embodiment are driving lines while the second scan lines 15a˜15e are sensing lines, however the present disclosure is not limited thereto.

The difference between the capacitive touch panel 40 of FIG. 4 and the capacitive touch panel 10 of FIG. 1 is in the circuitry structure of the first scan lines 43a˜43c. In the instant embodiment, each of the first scan lines 43a˜43c is formed of a single scan line. Each of the first scan lines crosses at least two sensing regions.

As shown in FIG. 4, the first scan line 43a crosses the sensing region R11 and the sensing region R12, which are capacitively formed between the first scan line 43a and the respective second scan line 15a. The first scan line 43a crosses the sensing region R21 and the sensing region R22, which are capacitively formed between the first scan line 43a and the respective second scan line 15b. The first scan line 43a crosses the sensing region R31 and the sensing region R32, which are capacitively formed between the first scan line 43a and the respective second scan line 15c, and so on.

The first scan line 43b crosses the sensing region R12 and the sensing region R13, which are capacitively formed between the first scan line 43b and the respective second scan line 15a. The first scan line 43b crosses the sensing region R22 and the sensing region R23, which are capacitively formed between the first scan line 43b and the respective second scan line 15b, and so on.

Similarly, the first scan line 43c crosses the sensing region R13 and the sensing region R14 which are capacitively formed between the first scan line 43c and the respective second scan line 15a. The first scan line 43c crosses the sensing region R23 and the sensing region R24, which are capacitively formed between the first scan line 43c and the respective second scan line 15b, and so on.

That is to say, at least a sensing region on the capacitive touch panel 40 covers a plurality of first scan lines 43a˜43c. For instance, the sensing regions R12, R22, R32, R42, and R52 respectively covers the first scan lines 43a and 43b; the sensing regions R13, R23, R33, R43, and R33 respectively covers the first scan lines 43b and 43c.

Specifically, the width of the first scan line 43a in the instant embodiment is at least greater than or equal to the spacing between the conducting wires 131 and 132 of the first scan line 13a on the capacitive touch panel 10 in FIG. 1. The width of the first scan line 43b in the instant embodiment is at least greater than or equal to the spacing between the conducting wires 133 and 134 of the first scan line 13b on the capacitive touch panel 10 in FIG. 1. The width of the first scan line 43c in the instant embodiment is at least greater than or equal to the spacing between the conducting wires 135 and 136 of the first scan line 13c on the capacitive touch panel 10 in FIG. 1.

When the capacitive touch panel 40 is integrated with a controller (not shown), the controller may determine the sensing region being touched based on the change in capacitance (e.g., mutual capacitance variation) sensed from two adjacent first scan lines 43a, 43b, and 43c so as to identify the touch position, accordingly. The rest of the circuitry structure and the operation of the capacitive touch panel 40 in FIG. 4 are essential the same as the capacitive touch panel 10, thus based on the above elaborations, those skilled in the art should be able to infer the operation associated with the capacitive touch panel 40, hence further descriptions are therefore omitted. FIG. 4 is merely used to illustrate an implementation of the capacitive touch panel provided in accordance to the instant embodiment of the present disclosure, and the present disclosure is not limited thereto.

(Another Exemplary Embodiment of a Capacitive Touch Panel)

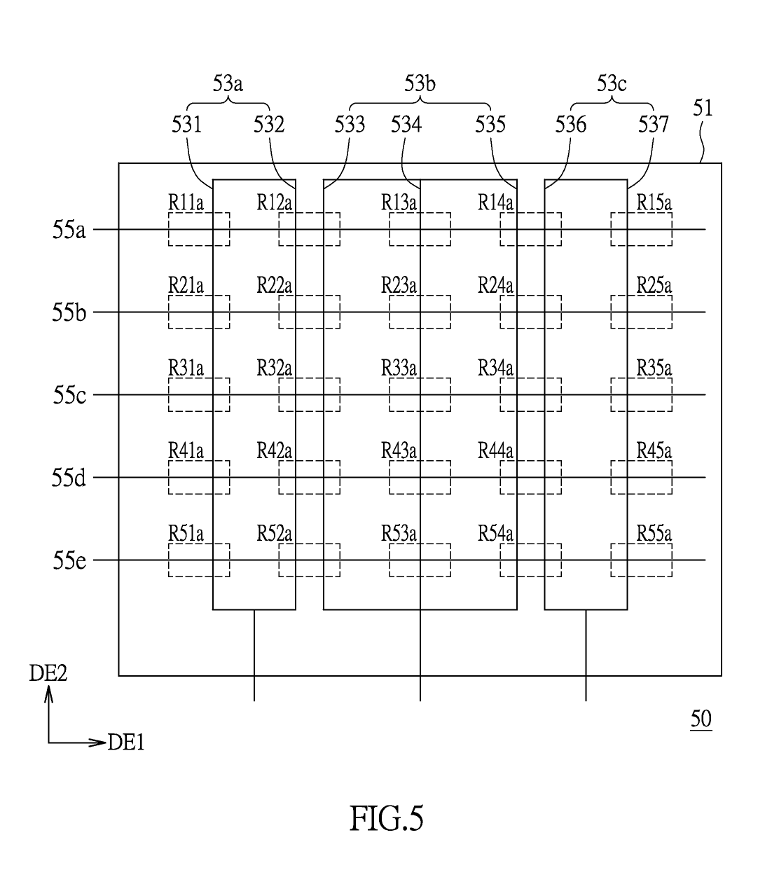

Please refer to FIG. 5, which shows a schematic diagram of a circuit layout on a capacitive touch panel provided in accordance to an exemplary embodiment of the present disclosure. The capacitive touch panel 50 includes a plurality of first scan lines 53a˜53c and a plurality of second scan lines 55a˜55e. The first scan lines 53a˜53c are arranged in parallel along a first axis DE1 (e.g., x-axis) direction of the substrate 51, and the second scan lines 55a˜55e are arranged in parallel along a second axis DE2 (e.g., y-axis) direction of the substrate 51. The first scan lines 53a˜53c and the second scan lines 55a˜55e arranged on the substrate 51 are interlaced with each other. The first scan lines 53a˜53c and the second scan lines 55a˜55e collectively form a plurality of sensing regions R11a˜R55a therebetween. Additionally, at least one of the first scan lines 53a˜55c forms a plurality of sensing regions with the second scan lines 55a˜55e on the capacitive touch pane 50. Each second scan line (e.g., the second scan line 55a, 55b, 55c, 55d, or 55e) may form a sensing region with one or multiple of the first scan lines 53a˜55c. In the instant embodiment, the first scan lines 53a˜53c are driving lines while the second scan lines 55a˜55e are sensing lines, however the present disclosure is not limited thereto.

The difference between the capacitive touch panel 50 of FIG. 5 and the capacitive touch panel 10 of FIG. 1 is in the circuitry structure of the first scan lines 53a˜53c. In the instant embodiment, the first scan lines 53a˜53c form a sensing region with each of the second scan lines 55a˜55e, respectively. Any two adjacent first scan lines (e.g., first scan lines 53a and 53b, first scan lines 53b and 53c) simultaneously form a sensing region with one of the second scan lines 55a˜55e.

Briefly, the outermost first scan lines (e.g., the first scan lines 53a or 53c) on the capacitive touch panel 50 intersect any of the second scan lines 55a˜55e to collectively form two sensing regions. At least a first scan line intersects with any of the second scan lines 55a˜55e to collectively form three sensing regions.

To put it concretely, the first scan line 53a is capacitively coupled to the second scan line 55a to forms a sensing region R11a. The first scan line 53a and the first scan line 53b are simultaneously capacitively coupled to the second scan line 55a collectively forming the sensing region R12a. The first scan line 53b is capacitively coupled to the second scan line 55a to forms a sensing region R13a. The first scan line 53b and the first scan line 53c are simultaneously capacitively coupled to the second scan line 55a collectively forming the sensing region R14a. The first scan line 53b is capacitively coupled to the second scan line 55a to form a sensing region R15a.

Particularly, the first scan line 53a includes a conducting wire 531 and a conducting wire 532, wherein the conducting wire 531 and the conducting wire 532 are connected in parallel. The first scan line 53b includes a conducting wire 533 and a conducting wire 534, wherein the conducting wire 533 and the conducting wire 534 are connected in parallel. The first scan line 53c includes a conducting wire 535 and a conducting wire 536, wherein the conducting wire 535 and the conducting wire 536 are connected in parallel.

The conducting wire 531 of the first scan line 53a is capacitively coupled to the second scan line 55a forming the sensing region R1 la. The conducting wire 532 of the first scan line 53a and the conducting wire 533 of the first scan line 53b are simultaneously capacitively coupled to the second scan line 55a collectively forming the sensing region R12a. The conducting wire 534 of the first scan line 53b is capacitively coupled to the second scan line 55a forming the sensing region R13a. The conducting wire 535 of the first scan line 53b and the conducting wire 536 of the first scan line 53c are simultaneously capacitively coupled to the second scan line 55a collectively forming the sensing region R14a. The conducting wire 537 of the first scan line 53c is capacitively coupled to the second scan line 55a forming the sensing region R15a.

Similarly, the conducting wires 531˜537 of the respective first scan lines 53a˜53c are individually capacitively coupled to the second scan line 55b, or simultaneously capacitively coupled to the second scan line 55b with the adjacent conducting wire to form a plurality of sensing regions R21a˜R25a. The conducting wires 531˜537 of the respective first scan lines 53a˜53c are individually capacitively coupled to the second scan line 55c, or simultaneously capacitively coupled to the second scan line 55c with the adjacent conducting wire forming a plurality of sensing regions R31a˜R35a and so on.

Accordingly, when the capacitive touch panel 50 is connected to a controller (not shown), the controller may determine which of the sensing regions has been touched by simultaneously comparing the voltage variation sensed from three adjacent first scan lines (i.e., first scan lines 53a˜53c) so as to locate the position of a touch position.

For instance, the controller simultaneously scan the first scan lines 53a˜53c, when the controller only detects change in the capacitance value sensed by the first scan line 53a and the respective second scan line 55a (e.g., the change in the capacitance value is greater than a predetermined sensing threshold), the controller determines that the sensing region R11a has been touched. When the controller simultaneously detects changes in the capacitance values sensed by the first scan line 53a, the first scan line 53b, and the respective second scan line 55a (e.g., the change in the capacitance value is greater than the predetermined sensing threshold), the controller determines that the sensing region R12a has been touched.

Moreover, when the controller only detects change in the capacitance value sensed by the first scan line 53b and the respective second scan line 55a (e.g., the change in the capacitance value is greater than the predetermined sensing threshold), the controller determines that the sensing region R13a has been touched. When the controller simultaneously detects variations in the capacitance values sensed by the first scan line 53b, the first scan line 53c, and the respective second scan line 55a (e.g., the change in the capacitance value is greater than the predetermined sensing threshold), the controller determines that the sensing region R14a has been touched. When the controller only detects change in the capacitance value sensed by the first scan line 53c and the respective second scan line 55a (e.g., the change in the capacitance value is greater than the predetermined sensing threshold), the controller determines that the sensing region R15a has been touched.

It is worth to mention that the first one (e.g., the first scan line 53a) of the first scan lines 53a˜53c and the last one (e.g., the first scan line 53c) of the first scan lines 53a˜53c on the capacitive touch panel 50 capacitively form two sensing regions with each of the respective second scan lines 55a˜55e. The first scan line (e.g., the first scan line 53b) disposed between the first and the last one of the first scan lines is capacitively coupled to form three sensing regions with each of the respective second scan lines 55a˜55e. That is, in the instant embodiment, at least a first scan line disposed between the first one (e.g., the first scan line 53a) and the last one (e.g., the first scan line 53c) of the first can lines 53a˜53c on the capacitive touch panel 50 forms three sensing regions with each of the respective second scan lines 55a˜55e.

Additionally, the first scan lines 53a˜53c of the instant embodiment comprise of two or three adjacent conducting wires connected in parallel. However, the first scan lines 53a˜53c may be also implemented by connected two or three adjacent conducting wires in series. Alternatively, the first scan lines 53a˜53c may be implemented by a single conducting wire, wherein the conducting wire at least crosses two or three sensing regions. The first scan lines 53a˜53c may be respectively implemented by a single conducting wire or by connecting two or three conducting wires in series or in parallel depend upon on actual operational or design requirements, and the present disclosure is not limited thereto. Based on the above explanation, those skilled in the art shall be able to infer the implementation of the first scan lines 53a˜53c on the capacitive touch panel 50 and further descriptions are hereby omitted.

It shall be noted that FIG. 5 is merely used to illustrate an implementation of the capacitive touch panel and the present disclosure is not limited thereto.

(Another Exemplary Embodiment of a Capacitive Touch Panel)

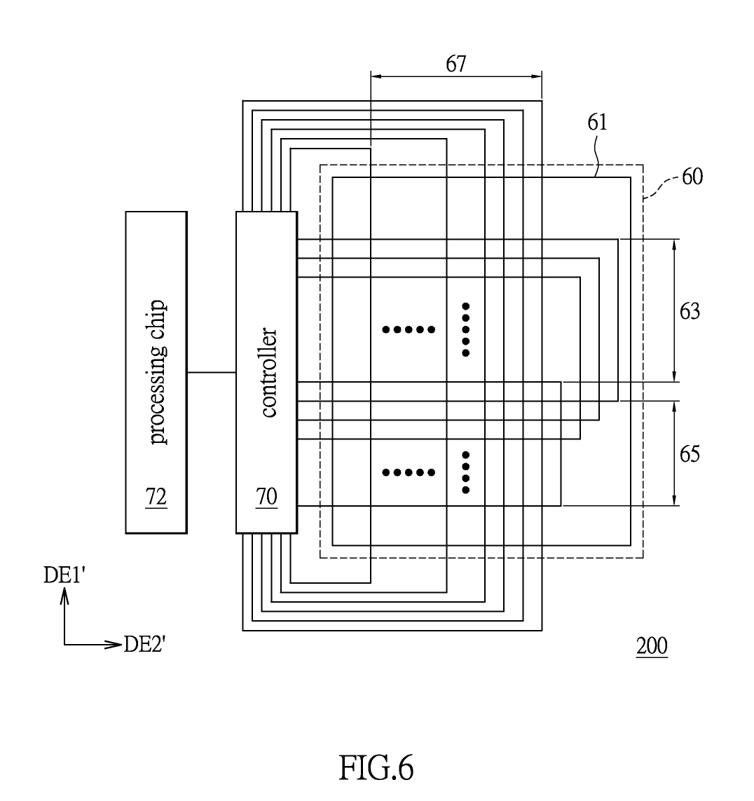

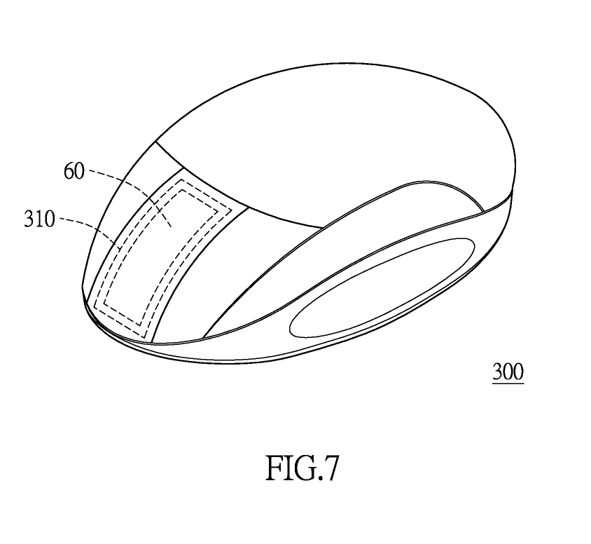

Please refer to FIG. 6 which shows a schematic diagram of an input device provided in accordance to an exemplary embodiment of the present disclosure. The input apparatus 200 may be adopted in an electronic device including but not limited to a keyboard and a mouse (e.g., a scrolling wheel mouse. The input device 200 includes a capacitive touch panel 60, a controller 70, and a processing chip 72. The capacitive touch panel 60 is coupled to the controller 70. The controller 70 is coupled to the processing chip 72.

The capacitive touch panel 60 includes a substrate 61, a first group of scan lines 63, a second group of scan lines 65, and a third group of scan lines 67. The substrate 61 may be a transparent insulating substrate such as a glass, a plastic, or any other transparent material with insulating characteristic. The first group of scan lines 63, the second group of scan lines 65, and the third group of scan lines 67 are formed on the substrate 61, respectively. In practice, the first group of scan lines 63, the second group of scan lines 65, and the third group of scan lines 67 may be manufactured on the substrate 61 using lithography process including exposure, develop, and etching processes.

The first group of scan lines 63 includes a plurality of conducting wires arranged in parallel along a first axis DE1′ (e.g., y-axis) direction of the substrate 61. The second group of scan lines 65 includes a plurality of conducting wires arranged in parallel along the first axis DE1′ (e.g., y-axis) direction of the substrate 61. The third group of scan lines 67 includes a plurality of conducting wires arranged in parallel along a second axis DE2′ (e.g., x-axis) direction of the substrate 61. The conducting wires of the third group of scan lines 67 are interlaced with the conducting wires of the first group of scan lines 63 and the second group of scan lines 65 while electrically isolated from the conducting wires of the first group of scan lines 63 and the second group of scan lines 65.

The conducting wires of the first group of scan lines 63 are sequentially and electrically connected to the conducting wires of the second group of scan lines 65 in series. Particularly, the zth conducting wire of the first group of scan lines 63 is electrically connected to the zth conducting wire of the second group of scan lines 65 in series, wherein z is an integer. For instance, the 1^{st} conducting wire of the first group of scan lines 63 is connected to the 1^{st} conducting wire of the second group of scan lines 65 in series. The 2^{nd} conducting wire of the first group of scan lines 63 is connected to the 2^{nd} conducting wire of the second group of scan lines 65 in series. The 3^{rd} conducting wire of the first group of scan lines 63 is connected to the 3^{rd} conducting wire of the second group of scan lines 65 in series, and so on.

It is worth to note that the first group of scan lines 63 and the second group of scan lines 65 in the instant embodiment have same number of conducting lines. The number of conducting wires in the third group of scan lines 67 is less than or equal to the number of conducting wires in either the first group of scan lines 63 or the second group of scan lines 65.

Accordingly, the capacitive touch panel 60 may at least reduce the number of conducting wires required on the conventional capacitive touch panel by half, thereby effectively lower the power consumption of the capacitive touch panel 60 as well as the number of conversion circuits and the pins of the controller required.

The controller 70 is coupled to the first group of scan lines 63, the second group of scan lines 65, and the third group of scan lines 67. The controller 70 may determine whether any of the sensing regions has been touched, the associated touch position, and the relative moving direction according to the scan results of the first group of scan lines 63, the second group of scan lines 65, and the third group of scan lines 67. The processing chip 72 may thus initiate a function (e.g. control the operation of a scroll bar of a window) according to a touch signal, wherein the touch signal is generated based on the displacement, the moving direction, and the moving speed associated with the touch position detected. The controller 70 and the processing chip 72 in practice may be implemented by a microcontroller with necessary firmware stored therein.

Incidentally, those skilled in art should know that the processing chip 72 can identify the change in capacitance value sensed by the zth conducting wire in the first group of scan lines 63 and the zth conducting wire in the second group of scan lines 65 through firmware design. Accordingly, the issue of having the cursor movement on the display being different from the actual finger operation (e.g., opposite to actual finger operating direction) when the finger operation is a zoom-in or a zoom-out operation can be avoided. Additionally, the occurrence of simultaneously detecting two touch positions for a single touching operation located at the boundary between the first group of scan lines 63 and the second group of scan lines 65 resulting in malfunction can be effectively prevented.

While the capacitive touch panel 60 is in operation, the variation in coupling inductance simultaneously sensed by the zth conducting lines in the first group of scan lines 63 and the respective conducting wires in the third group of scan lines 67 is substantially the same as the variation in coupling inductance simultaneously sensed by the zth conducting lines in the second group of scan lines 65 and the respective conducting wires in the third group of scan lines 67. Accordingly, when the controller 70 sequentially drives the conducting wires in the first group of scan lines 63 and the second group of scan lines 65, the controller 70 would sequentially receive identical sensing signals from the respective conducting wires so as to generate same touching signal repeatedly e.g., left/right or up/down cyclic movement. Preferably, the capacitive touch panel 60 can operatively detect continually touching operations such as scrolling operation, e.g., a roller operation of a mouse or a scrolling operation of a keyboard.

Please refer to FIG. 7 in conjunction with FIG. 6, which shows a diagram illustrating an implementation of the input apparatus applied in a mouse provided in accordance to an exemplary embodiment of the present disclosure. The input apparatus 200 may be used for controlling the operation of a roller 310 in the mouse 300. For instance, when the capacitive touch panel 60 is used as a roller control unit for the mouse 300, the processing chip 72 can initiate a scrolling operation corresponding to the rolling operation of the roller unit on the mouse 300 based on the touching signal.

It shall be noted that FIG. 6 is merely used to illustrate an implementation of the capacitive touch panel and the present disclosure is not limited thereto. Also, FIG. 7 is merely used to illustrate an application of the capacitive touch panel in a mouse, and the present disclosure is not limited thereto.

(An Exemplary Embodiment of a Sensing Method for a Capacitive Touch Panel)

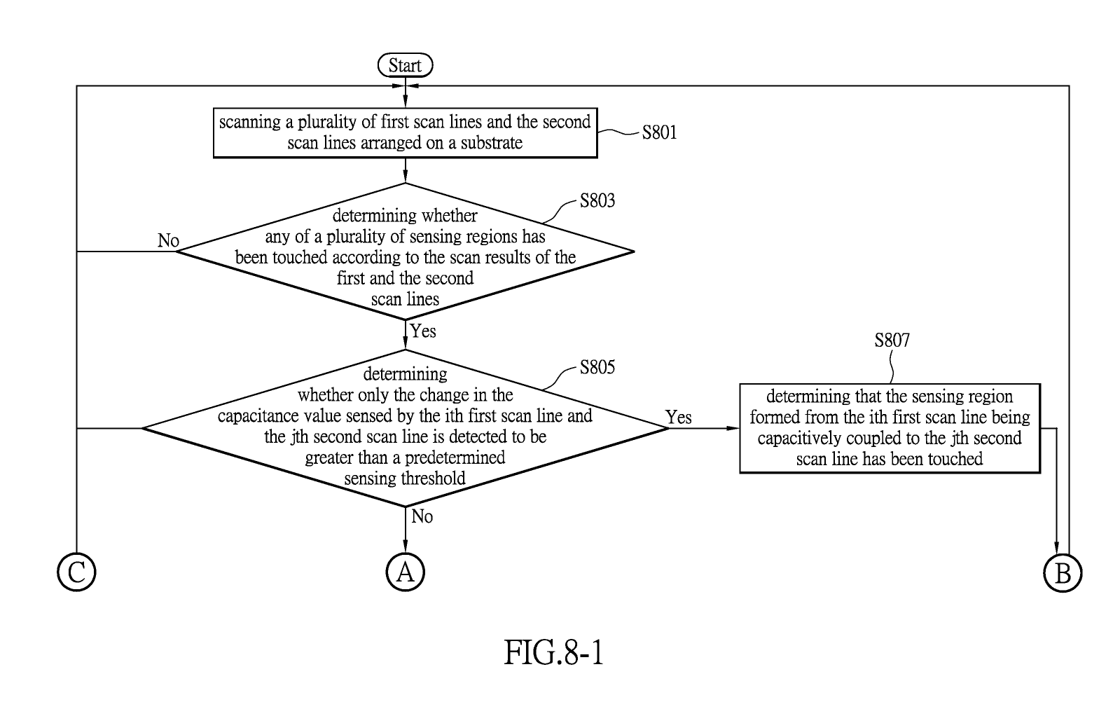

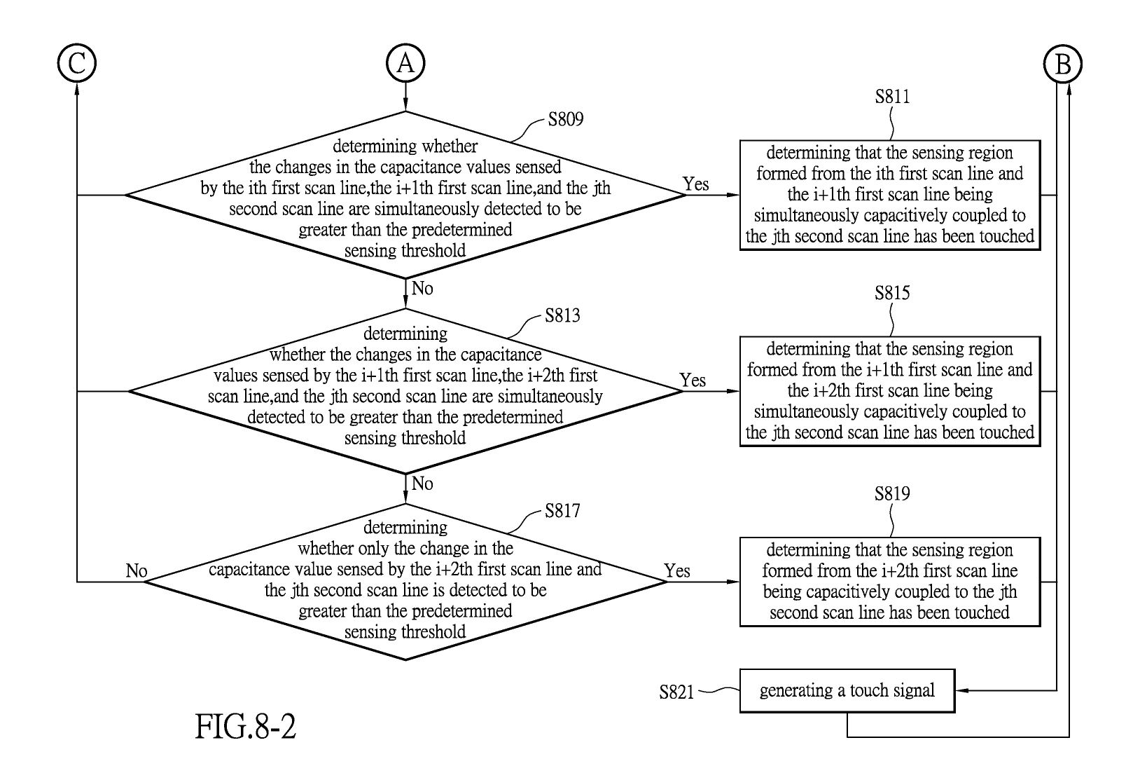

From the aforementioned exemplary embodiments, the present disclosure may generalize a sensing method for a capacitive touch panel illustrated in the aforementioned embodiment. Please refer to FIG. 8-1 and FIG. 8-2 in conjunction with FIG. 1. FIG. 8-1 and FIG. 8-2 respectively show flowchart diagrams illustrating a sensing method for a capacitive touch panel provided in accordance to an exemplary embodiment of the present disclosure.

In Step S801, a plurality of first scan lines 13a˜13c and a plurality of the second scan lines 15a˜15e arranged on a substrate 11 are sequentially scanned, wherein the first scan lines 13a˜13c are interlaced with the second scan lines 15a˜15e. Whether any of a plurality of sensing regions R11˜R54 capacitively formed among the first scan lines 13a˜13c and the second scan lines 15a˜15e has been touched is subsequently determined according to the scan results of the first scan lines 13a˜13c and the second scan lines 15a˜15e in Step S803. When determined that the plurality of sensing regions R11˜R54 has been touched (e.g., the sensing regions R11˜R54 has been touched by a finger or a conductor), executes Step S805; otherwise, returns to Step S801.

Next, in Step S805, determines whether only the change in the capacitance value sensed by the ith first scan line (e.g., the first scan line 13a) and the jth second scan line (e.g., the second scan line 15a) is detected to be greater than a predetermined sensing threshold. When only detects that the change in the capacitance value sensed by the ith first scan line (e.g., the first scan line 13a) and the jth second scan line (e.g., the second scan line 15a) is greater than the predetermined sensing threshold, executes S807; otherwise executes S809. In Step S807, the sensing region (e.g. the sensing region R11) formed from the ith first scan line being capacitively coupled to the jth second scan line is determined to be touched and executes Step S821.

Next, in Step S809, determines whether the changes in the capacitance values sensed by the ith first scan line (e.g., the first scan line 13a), the i+1th (e.g., the first scan line 13b) first scan line, and the jth second scan line (e.g., the first scan line 15a) are simultaneously detected to be greater than the predetermined sensing threshold. When simultaneously detects that the changes in the capacitance values sensed by the ith first scan line (e.g., the first scan line 13a), the i+1th (e.g., the first scan line 13b) first scan line, and the jth second scan line (e.g., the second scan line 15a) are greater than the predetermined sensing threshold, executes Step S811; otherwise, executes Step S813. In Step S811, the sensing region (e.g., the sensing region R12) formed from the ith first scan line (e.g., the first scan line 13a) and the i+1th (e.g., the first scan line 13b) first scan line being simultaneously capacitively coupled to the jth second scan line (e.g., the second scan line 15a) is determined to be touched and executes Step S821.

In Step S813, determines whether the changes in the capacitance values sensed by the i+1th first scan line (e.g., the first scan line 13b), the i+2th (e.g., the first scan line 13c) first scan line, and the jth second scan line (e.g., the first scan line 15a) are simultaneously detected to be greater than the predetermined sensing threshold. When simultaneously detects that the changes in the capacitance values sensed by the i+1th first scan line (e.g., the first scan line 13b), the i+2th (e.g., the first scan line 13c) first scan line, and the jth second scan line (e.g., the second scan line 15a) are greater than the predetermined sensing threshold, executes Step S815; otherwise, executes Step S817. In Step S815, the sensing region (e.g., the sensing region R13) formed from the i+1th first scan line (e.g., the first scan line 13b) and the i+2th (e.g., the first scan line 13c) first scan line being simultaneously capacitively coupled to the jth second scan line (e.g., the second scan line 15a) is determined to be touched and executes Step S821.

In Step S817, determines whether only the change in the capacitance value sensed by the i+2th first scan line (e.g., the first scan line 13c) and the jth second scan line (e.g., the second scan line 15a) is detected to be greater than the predetermined sensing threshold. When only detects that the change in the capacitance value sensed by the i+2th first scan line (e.g., the first scan line 13c) and the jth second scan line (e.g., the second scan line 15a) is greater than the predetermined sensing threshold, executes S819; otherwise returns to Step S801. In Step S819, the sensing region (e.g., the sensing region R14) formed from the i+2th first scan line (e.g., the first scan line 13c) being capacitively coupled to the jth second scan line (e.g., the second scan line 15a) is determined to be touched and executes Step S821.

In Step S821, a touch signal is generated according to the position of the sensing region being determined to be touched. Then, returns to Step S801 to rescan the capacitive touch panel 10.

It is worth to note that, in the instant embodiment, i, j, and k are integers. The predetermined sensing threshold may be configured based on the detection and/or operational requirements of the capacitive touch panel, and the present disclosure is not limited thereto. The detection method for the sensing regions R21˜R54 on the capacitive touch panel 10 is essentially the same as for the sensing regions R11˜R14. Based on the above elaborations, those skilled in the art should be able to infer the detection method for the sensing region R21˜R54, thus further descriptions are therefore omitted.

The sensing method depicted in FIG. 8-1 and FIG. 8-2 may be implemented by writing firmware onto the controller (not shown) connected to the capacitive touch panel 10 for performing the driving and scanning operations to the capacitive touch panel 10. Additionally, the sensing method depicted in FIG. 8-1 and FIG. 8-2 may also be adopted for the capacitive touch panels illustrated by FIG. 2, FIG. 3, and FIG. 4. It shall be noted that FIG. 8-1 and FIG. 8-2 merely serve to illustrate a sensing method for a capacitive touch panel, and the present disclosure is not limited thereto.

(Another Exemplary Embodiment of a Sensing Method for a Capacitive Touch Panel)

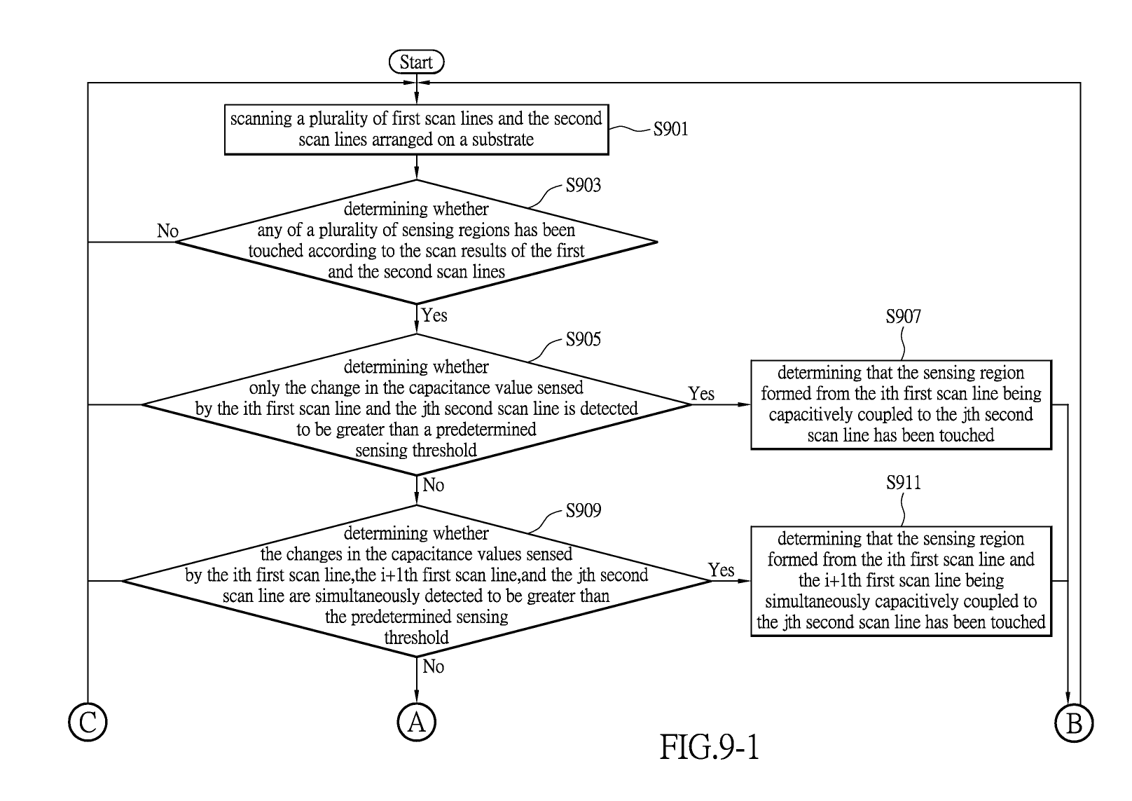

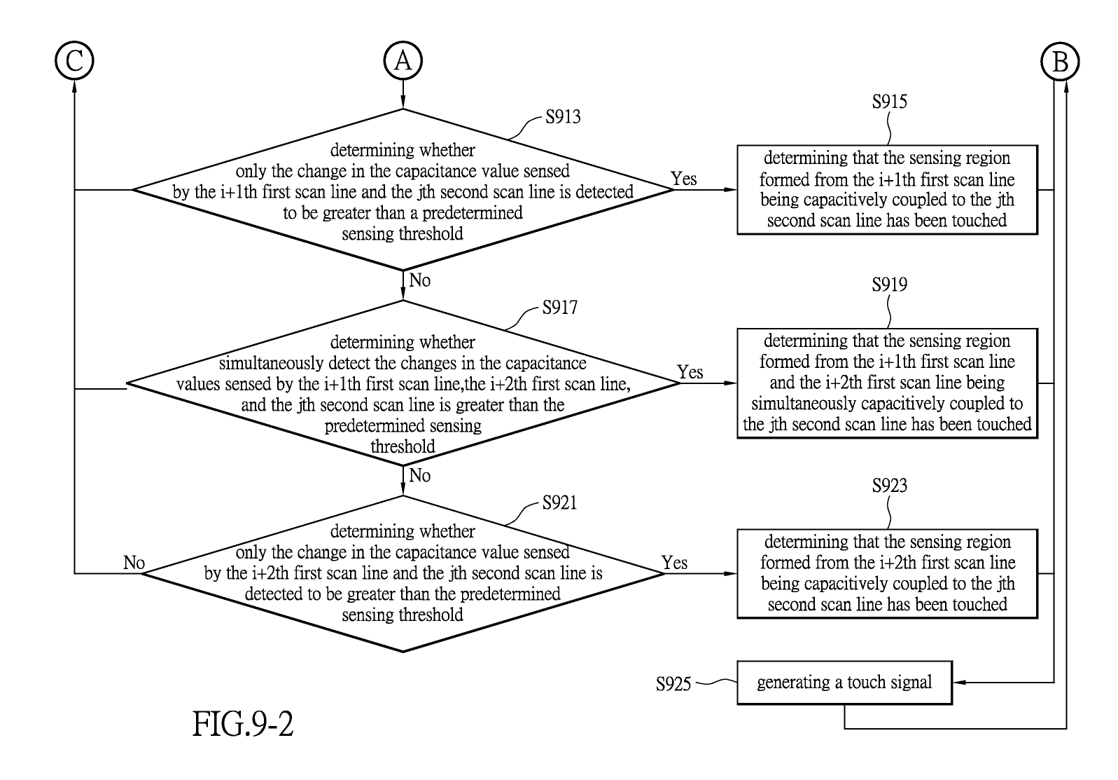

From the aforementioned exemplary embodiments, the present disclosure may generalize another sensing method which is adapted for a capacitive touch panel illustrated in FIG. 5. Please refer to FIG. 9-1 and FIG. 9-2 in conjunction to FIG. 5. FIG. 9-1 and FIG. 9-2 respectively show flowchart diagrams illustrating a sensing method for a capacitive touch panel provided in accordance to an exemplary embodiment of the present disclosure.

In Step S901, a plurality of first scan lines 53a˜53c and a plurality of second scan lines 55a˜55e interlaced with the first scan lines 53a˜53c being arranged on a substrate 51 are sequentially scanned. Whether any of a plurality of sensing regions R11a˜R55a capacitively formed between the first scan lines 53a˜53c and the second scan lines 55a˜55e has been touched is subsequently determined according to the scan results of the first scan lines 53a˜53c and the second scan lines 55a˜55e in Step S803. When determine that the plurality of sensing regions R11˜R55 has been touched (e.g., the sensing regions R11a˜R55a has been touched by a finger or a conductor), executes Step S905; otherwise, returns to Step S901.

To put it concretely, a controller (not shown) connected to the first scan lines 53a˜53c and the second scan lines 55a˜55e. The controller may simultaneously drive the first scan lines 53a˜53c and sequentially receive the corresponding sensing signals so as to determine whether the sensing regions R1a˜R55a has been touched.

In Step S905, the controller determines whether only the change in the capacitance value sensed by the ith first scan line (e.g., the first scan line 53a) and the jth second scan line (e.g., the second scan line 55a) is detected to be greater than a predetermined sensing threshold. When the controller only detects that the change in capacitance value sensed by the ith first scan line (e.g., the first scan line 53a) and the jth second scan line (e.g., the second scan line 55a) is greater than the predetermined sensing threshold, executes S907; otherwise executes S909.

In Step S907, the controller determines that the sensing region (e.g. the sensing region R11a) formed from the ith first scan line (e.g., the first scan line 53a) being capacitively coupled to the jth second scan line (e.g., the second scan line 55a) has been touched and executes Step S925.

Next, in Step S909, the controller determines whether the changes in the capacitance values sensed by the ith first scan line (e.g., the first scan line 53a), the i+1th (e.g., the first scan line 53b) first scan line, and the jth second scan line (e.g., the second scan line 55a) are simultaneously detected to be greater than the predetermined sensing threshold. When the controller simultaneously detects that the changes in the capacitance values sensed by the ith first scan line (e.g., the first scan line 53a), the i+1th (e.g., the first scan line 53b) first scan line, and the jth second scan line (e.g., the second scan line 55a) are greater than the predetermined sensing threshold, executes Step S911; otherwise, executes Step S913.

In Step S911, the controller determines that the sensing region (e.g., the sensing region R12a) formed from the ith first scan line (e.g., the first scan line 53a) and the i+1th (e.g., the first scan line 53b) first scan line being simultaneously capacitively coupled to the jth second scan line (e.g., the second scan line 55a) has been touched and executes Step S925.

In Step S913, the controller determines whether only the change in the capacitance value sensed by the i+1th first scan line (e.g., the first scan line 53b) and the jth second scan line (e.g., the second scan line 55a) is detected to be greater than the predetermined sensing threshold. When the controller only detects that the change in the capacitance value sensed by the i+1th first scan line (e.g., the first scan line 53b) and the jth second scan line (e.g., the second scan line 55a) is greater than the predetermined sensing threshold, executes S915; otherwise executes Step S917.

In Step S915, the controller determines that the sensing region (e.g., the sensing region R13a) formed from the i+1th first scan line (e.g., the first scan line 53b) being capacitively coupled to the jth second scan line (e.g., the second scan line 55a) has been touched and executes Step S925.

In Step S917, the controller determines whether the changes in the capacitance values sensed by the i+1th first scan line (e.g., the first scan line 53b), the i+2th (e.g., the first scan line 53c) first scan line, and the jth second scan line (e.g., the second scan line 55a) are simultaneously detected to be greater than the predetermined sensing threshold. When the controller simultaneously detects that the changes in the capacitance values sensed by the i+1th first scan line (e.g., the first scan line 53b), the i+2th (e.g., the first scan line 53c) first scan line, and the jth second scan line (e.g., the second scan line 55a) are greater than the predetermined sensing threshold, executes Step S919; otherwise, executes Step S921.

In Step S919, the controller determines that the sensing region (e.g., the sensing region R14a) formed from the i+1th first scan line (e.g., the first scan line 53b) and the i+2th (e.g., the first scan line 53c) first scan line being capacitively coupled to the jth second scan line (e.g., the second scan line 55a) has been touched and executes Step S925.

In Step S921, the controller determines whether only the change in the capacitance value sensed by the i+2th first scan line (e.g., the first scan line 53c) and the jth second scan line (e.g., the second scan line 55a) is detected to be greater than the predetermined sensing threshold. When the controller only detects that the capacitance value sensed by the i+2th first scan line (e.g., the first scan line 53c) and the jth second scan line (e.g., the second scan line 55a) is greater than the predetermined sensing threshold, executes S923; otherwise. returns to Step S901. In Step S923, the controller determines that the sensing region (e.g., the sensing region R15a) formed from the i+2th first scan line (e.g., the first scan line 53c) being capacitively coupled to the jth second scan line (e.g., the second scan line 55a) has been touched and executes Step S925.

In Step S925, the controller generates a touch signal according to the position of the sensing region being determined to be touched. Then, returns to Step S901 to rescan the capacitive touch panel 50.

It is worth to note that, in the instant embodiment, i, j, and k are integers. The predetermined sensing threshold may be configured based on the detection and/or operational requirements of the capacitive touch panel, and the present disclosure is not limited thereto. The detection method for the sensing regions R21a˜R55a on the capacitive touch panel 50 is essentially the same as the sensing regions R11a˜R15a. Based on the above elaborations, those skilled in the art should be able to infer the detection method for the sensing region R21a˜R55a, thus further descriptions are therefore omitted.

The sensing method depicted in FIG. 9-1 and FIG. 9-2 may be implemented by writing firmware onto the controller for performing the driving and scanning operations to the capacitive touch panel 50. It shall be noted that FIG. 9-1 and FIG. 9-2 merely serve to illustrate a sensing method for a capacitive touch panel, and the present disclosure is not limited thereto.

In summary, an exemplary embodiment of the present disclosure provides a capacitive touch panel, a sensing method thereof, a touch device, and an input apparatus. The capacitive touch panel can accurately and precisely locate touch positions while effectively lower the overall power consumption through reducing the number of overall scan lines required. The capacitive touch panel disclosed may also route the peripheral traces connected to the scan lines form one side of the capacitive touch panel by grouping the scan lines so as to simplify the peripheral circuitry for the capacitive touch panel. Accordingly, the capacitive touch panel of the present disclosure not only can accurately locates the position of a touching point but also can reduce the overall power consumption through reducing the number of scan lines required and reduce the pins needed on the control chip. Such that the complexity and the associated production cost of the touch control circuitry may be reduced while the operational efficiency of the capacitive touch panel can be increased.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A capacitive touch panel, comprising:
a substrate;
a plurality of first scan lines, formed on the substrate, the first scan lines arranged in parallel along a first axis of the substrate; and
a plurality of second scan lines, formed on the substrate, the second scan lines arranged in parallel along a second axis of the substrate, and the second scan lines interlaced with the first scan lines, wherein the second scan lines are capacitively coupled to the first scan lines forming a plurality of sensing regions;
wherein the ith first scan line is capacitively coupled to the jth second scan line forming the kth sensing region; the ith first scan line and the i+1th first scan line are simultaneously capacitively coupled to the jth second scan line collectively forming the k+1 th sensing region; the i+1th first scan line is capacitively coupled to the jth second scan line forming the k+2th sensing region; wherein, i, j, and k are integers.

2. The capacitive touch panel according to claim 1, wherein the i+1th first scan line and the i+2th second scan line are simultaneously capacitively coupled to the jth second scan line collectively forming the k+2th sensing region.

3. The capacitive touch panel according to claim 1, wherein the ith first scan line comprises of two adjacent conducting wires connected in series or in parallel.

4. The capacitive touch panel according to claim 1, wherein the i+1th first scan line comprises of two adjacent conducting wires connected in series or in parallel.

5. The capacitive touch panel according to claim 1, wherein the ith first scan line crosses the kth sensing region and the k+1th sensing region.

6. The capacitive touch panel according to claim 1, wherein the i+1th first scan line crosses the k+1th sensing region and the k+2th sensing region.

7. The capacitive touch panel according to claim 1, wherein the first scan lines are driving lines while the second scan lines are sensing lines.

8. The capacitive touch panel according to claim 1, wherein the first scan lines are sensing lines while the second scan lines are driving lines.

9. A touch device, comprising:
a capacitive touch panel, comprising:
a substrate;
a plurality of first scan lines, formed on the substrate, the first scan lines arranged in parallel along a first axis of the substrate; and
a plurality of second scan lines, formed on the substrate, the second scan lines arranged in parallel along a second axis of the substrate, and the second scan lines interlaced with the first scan lines, wherein the second scan lines are capacitively coupled to the first scan lines forming a plurality of sensing regions; and
wherein the ith first scan line is capacitively coupled to the jth second scan line forming the kth sensing region; the ith first scan line and the i+1th first scan line are simultaneously capacitively coupled to the jth second scan line collectively forming the k+1th sensing region; the i+1th first scan line is capacitively coupled to the jth second scan line forming the k+2th sensing region; wherein, i, j, and k are integers;
a controller, coupled to the first scan lines and the second scan lines, determining whether any of the sensing regions has been touched based on the scan results of the first scan lines and the second scan lines.

10. The touch device according to claim 9, wherein when the controller only detects change in the capacitance value sensed by the ith first scan line and the jth second scan line, the controller determines that the kth sensing region has been touched; when the controller simultaneously detects changes in the capacitance values sensed by the ith first scan line, the i+1th first scan line, and the jth second scan line, the controller determines that the k+1th sensing region has been touched; when the controller only detects change in the capacitance value sensed by the i+1th first scan line and the jth second scan line, the controller determines that the k+2th sensing region has been touched.

11. A capacitive touch panel, comprising:
a substrate;
a first group of scan lines, formed on the substrate, the first group of scan lines comprising a plurality of conducting wires arranged in parallel along a first axis of the substrate;
a second group of scan lines, formed on the substrate, the second group of scan lines comprising a plurality of conducting wires arranged in parallel along the first axis of the substrate; and
a third group of scan lines, formed on the substrate, the third group of scan lines comprising a plurality of conducting wires arranged in parallel along the a second axis of the substrate, the conducting wires in the third group of the scan lines interlaced with the conducting wires in the first and the second groups of scan lines, while electrically isolated from the conducting wires in the first and the second groups of scan lines;
wherein the zth conducting wire of the first group of scan lines is connected in series with the zth conducting wires of the second group of scan lines, and z is an integer.

12. The capacitive touch panel according to claim 11, wherein the first group of scan lines has the same number of conducting wires as the second group of scan lines.

13. An input apparatus, which has the touch device according to claim 9.

14. The input apparatus according to claim 13, wherein the input apparatus further comprises of a processing chip, which is coupled to the touch device.

15. The input apparatus according to claim 13, wherein the input apparatus is a keyboard or a scrolling wheel mouse.

16. A sensing method for a capacitive touch panel, comprising:
scanning a plurality of first scan lines and a plurality of second scan lines interlaced with the first scan lines disposed on a substrate;
determining whether any of a plurality of sensing regions capacitively formed between the first scan lines and the second scan lines has been touched according to the scan results of the first and the second scan lines;
when only detects change in the capacitance value sensed by the ith first scan line and the jth second scan line, determines that the kth sensing region has been touched;
when simultaneously detects changes in the capacitance values sensed by the ith first scan line, the i+1th first scan line, and the jth second scan line, determines that the k+1th sensing region has been touched; and
when only detects change in the capacitance value sensed by the i+1th first scan line and the jth second scan line, determines that the k+2th sensing region has been touched;
wherein i, j, and k are integers.

17. The sensing method according to claim 16, wherein the step of determining whether any of the sensing regions has been touched comprises:
when only detects that the change in the capacitance value sensed by the ith first scan line and the jth second scan line is greater than a predetermined sensing threshold, determines that the kth sensing region has been touched;
when simultaneously detects that the changes in the capacitance values sensed by the ith first scan line, the i+1th first scan line, and the jth second scan line is greater than the predetermined sensing threshold, determines that the k+1th sensing region has been touched; and
when only detects that the change in the capacitance value sensed by the i+1th first scan line and the jth second scan line is greater than the predetermined sensing threshold, determines that the k+2th sensing region has been touched.

18. A sensing method for a capacitive touch panel, comprising:
scanning a plurality of first scan lines and second scan lines being staggeredly arranged on a substrate;
determining whether any of a plurality of sensing regions formed between the first scan lines and the second scan lines has been touched according to the scanning results of the first and the second scan lines;
when only detects change in the capacitance value sensed by the ith first scan line and the jth second scan line, determines that the kth sensing region has been touched;
when simultaneously detects changes in the capacitance values sensed by the ith first scan line, the i+1th first scan line, and the jth second scan line, determines that the k+1th sensing region has been touched;
when only detects change in the capacitance value sensed by the i+1th first scan line and the jth second scan line, determines that the k+2th sensing region has been touched;
when simultaneously detects changes in the capacitance values sensed by the i+1th first scan line, the i+2th first scan line, and the jth second scan line, determines that the k+3th sensing region has been touched; and
when only detects change in the capacitance value sensed by the i+2th first scan line and the jth second scan line, determines that the k+4th sensing region has been touched;
wherein i, j, and k are integers.

19. The sensing method according to claim 18, wherein the step of determining whether the sensing region has been touched comprises:
when only detects that the change in the capacitance value sensed by the ith first scan line and the jth second scan line is greater than a predetermined sensing threshold, determines that the kth sensing region has been touched;
when simultaneously detects that the changes in the capacitance values sensed by the ith first scan line, the i+1th first scan line, and the jth second scan line is greater than the predetermined sensing threshold, determines that the k+1th sensing region has been touched; and
when only detects that the change in the capacitance value sensed by the i+1th first scan line and the jth second scan line is greater than the predetermined sensing threshold, determines that the k+2th sensing region has been touched
when simultaneously detects that the changes in the capacitance values sensed by the i+1th first scan line, the i+2th first scan line, and the jth second scan line is greater than the predetermined sensing threshold, determines that the k+3th sensing region has been touched; and
when only detects that the change in the capacitance value sensed by the i+2th first scan line and the jth second scan line is greater than the predetermined sensing threshold, determines that the k+4th sensing region has been touched.

20. A capacitive touch panel, comprising:
a substrate;
a plurality of first scan lines, formed on the substrate, the first scan lines arranged in parallel along a first axis of the substrate; and
a plurality of second scan lines, formed on the substrate, the second scan lines arranged in parallel along a second axis of the substrate, and the second scan lines interlaced with the first scan lines, wherein the second scan lines are capacitively coupled to the first scan lines forming a plurality of sensing regions;
wherein at least a sensing region covers a plurality of first scan lines.

21. The capacitive touch panel according to claim 20, wherein the ith first scan line is in adjacent to the i+1th first scan line of the plurality of first scan lines covered by the sensing region.

22. The capacitive touch panel according to claim 21, wherein the ith first scan line and the i+1th first scan line collectively forming the sensing region with the jth second scan line.

23. The capacitive touch panel according to claim 21, wherein at least one of the ith first scan line and the i+1th first scan line comprises of two adjacent conducting wires connected in series or in parallel.

24. The capacitive touch panel according to claim 20, wherein the first scan lines are driving lines while the second scan lines are sensing lines.

25. The capacitive touch panel according to claim 20, wherein the first scan lines are sensing lines while the second scan lines are driving lines.
